(19) United States
(12) Patent Application Publication
(10) Pub. No.: US 2016/0147917 A1
(43) Pub. Date: May 26, 2016

(54) SIMULATION MODEL AND SIMULATION METHOD FOR ACQUIRING COOLING FLOW OF EXPANSION CARD

(71) Applicant: HON HAI PRECISION INDUSTRY CO., LTD., New Taipei (TW)

(72) Inventors: WEI-CHAN HSU, New Taipei (TW); CHIH-HANG CHAO, New Taipei (TW)

(21) Appl. No.: 14/575,853

(22) Filed: Dec. 18, 2014

(30) Foreign Application Priority Data
Nov. 25, 2014 (TW) 103140719

(51) Int. Cl. G06F 17/50; G06F 17/10

(52) U.S. Cl. CPC G06F 17/5009; G06F 17/10

(57) ABSTRACT

A method for acquiring a cooling flow of an expansion card is provided. The expansion card is connected to a circuit board of a host. The host further includes a shell, a power supply unit, a hard disk, a central processor unit, a storage unit and a fan. The method includes building up a model in a thermal simulation software and setting up thermal parameters. The model includes a circuit board, an expansion card and a fan. Structures and positions of the model are same as the host. The method further includes simulating a relationship between the cooling flow of the expansion card of the host and a temperature of the expansion card of the host through a simulation function of the thermal simulation software based on the model and the thermal parameters. The disclosed subject matter also provides a simulation model.

### CROSS-REFERENCE TO RELATED APPLICATIONS

This application claims priority to Taiwan Patent Application No. 103140719, filed on Nov. 25, 2014, the contents of which are incorporated by reference herein.

### FIELD

The subject matter herein relates to a simulation model and simulation method for acquiring cooling flow of an expansion card.

### BACKGROUND

When a host is working, circuit boards in the host generate heat. The heat is transferred to an expansion card connected to the circuit board to increase a temperature of the expansion card. A fan is employed in the host to cool down the expansion card. The cooling flow of the expansion card is simulated in a thermal simulation software through a complete simulation model having a same structure as the host. Because the complete simulation model includes all members of the host, thermal parameters are too many. Thus, a computational complexity is increased, and a time of the simulation through the complete simulation model is long.

### BRIEF DESCRIPTION OF THE DRAWINGS

Implementations of the present technology will now be described, by way of example only, with reference to the attached figures.

FIG. 1 is an isometric view of a host.

FIG. 2 is similar to FIG. 1, but with a shell omitted.

FIG. 3 is a chart of a part of data of a cooling flow of the expansion card and a corresponding temperature of the expansion card acquired through a complete simulation model.

FIG. 4 is an isometric view of a simplified simulation model.

FIG. 5 is a chart of a part of data of a cooling flow of the expansion card and a corresponding temperature of the expansion card acquired through the simplified simulation model in FIG. 4.

FIG. 6 is a graph of the relationship between the cooling flow of the expansion card and the corresponding temperature of the expansion card acquired through the complete simulation model and the simplified simulation model.

FIG. 7 is a flowchart of a method to acquire the relationship between the cooling flow of the expansion card and the temperature of the expansion card.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series, and the like.

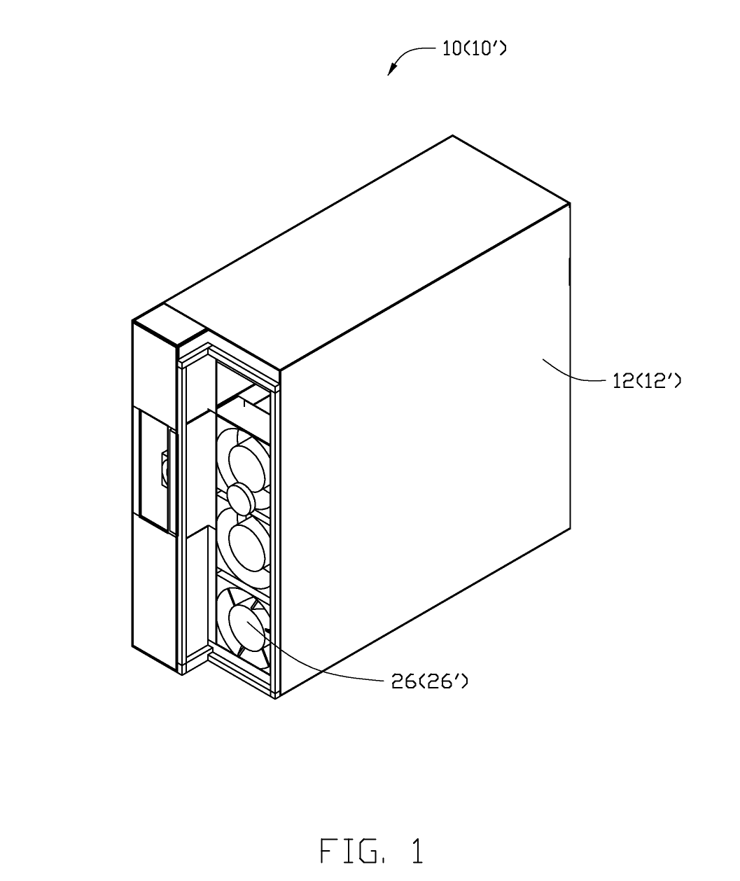

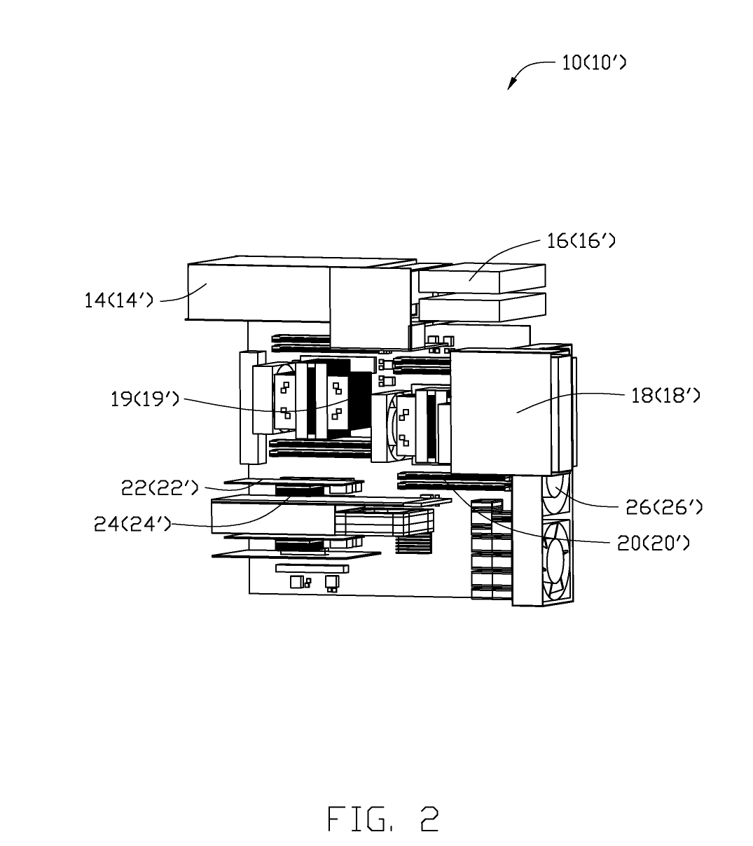

FIGS. 1 and 2 illustrate a host 10 includes a shell 12, a power supply unit 14, a hard disk 16, an optical disc driver 18, a central processor unit 19, a storage unit 20, a printed circuit board 22, an expansion card 24 and a fan 26. The power supply unit 14, the hard disk 16, the optical disc driver 18, the central processor unit 19, the storage unit 20, the printed circuit board 22, the expansion card 24 and the fan 26 are attached in the shell 12. The expansion card 24 is electrically connected to the printed circuit board 22. The power supply unit 14 is configured to be electrically connected to supply power to the hard disk 16, the optical disc driver 18, the central processor unit 19, the storage unit 20, the printed circuit board 22, the expansion card 24 and the fan 26. When the host is working, the hard disk 16, the optical disc driver 18, the central processor unit 19, the storage unit 20, the printed circuit board 22, the expansion card 24 all generate heat. A part of the heat generated by the printed circuit board 22 is transferred to the expansion card 24. Thus, a temperature of the expansion card 24 is increased. The fan 26 is opposite to the printed circuit board 22 to dissipate the heat generated by the host 10 to cool down the expansion card 24. The expansion card 24 can be a network card, an adapter card, a sound card or a video card.

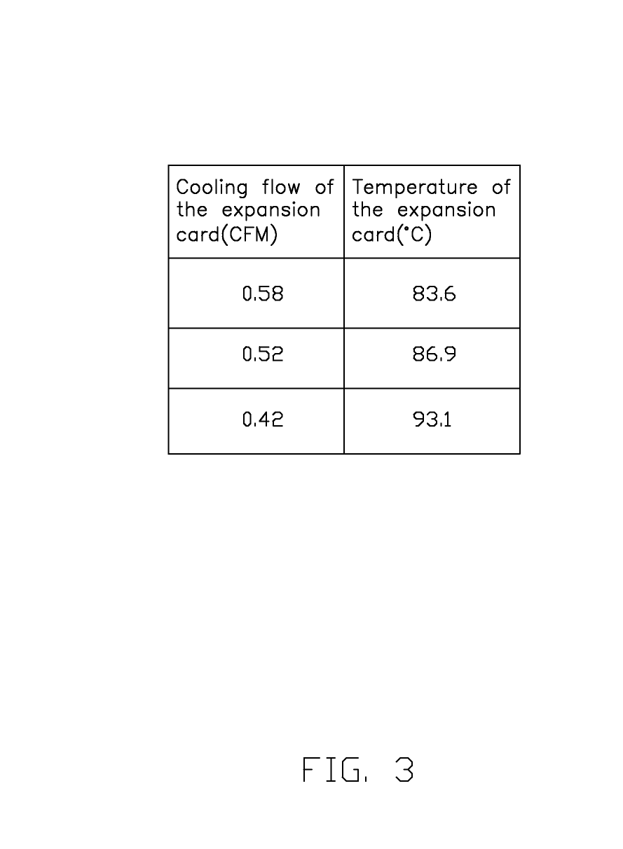

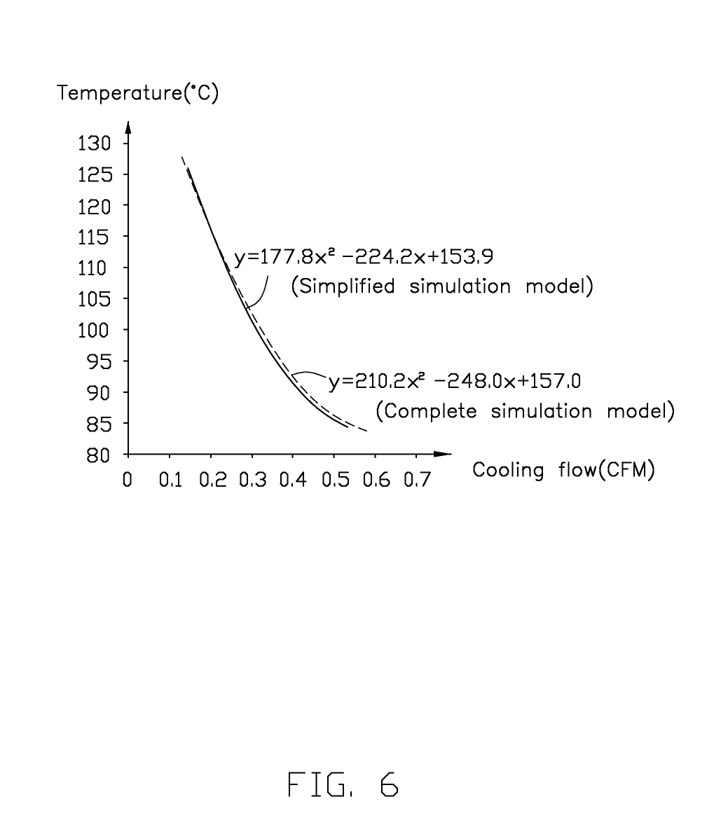

A complete simulation model 10′ having a structure same as the host 10 is built in a thermal simulation software and is simulated in the thermal simulation software to acquire the relationship for acquiring a relationship between a cooling flow of the expansion card 24 and the temperature of the expansion card 24. The thermal simulation software can be Flotherm 3.0. The complete simulation model 10′ includes a shell 12′, a power supply unit 14′, a hard disk 16′, an optical disc driver 18′, a central processor unit 19′, a storage unit 20′, a printed circuit board 22′, an expansion card 24′ and a fan 26′. When to acquire the relationship between the cooling flow of the expansion card 24 and the temperature of the expansion card 24, the expansion card 24′ is set up as an object to be simulated in the thermal simulation software. Further set up boundary values of thermal conductivity and heat productivity of the shell 12′, the hard disk 16′, the optical disc driver 18′, the central processor unit 19′, the storage unit 20′, the printed circuit board 22′ and the expansion card 24′, and boundary value of a flow of the fan 26′ and an environment temperature of the host 10′. Then the relationship is acquired through a simulation function of the thermal simulation software. FIG. 3 illustrates a part of a date of the cooling flow of the expansion card 24 and the corresponding temperature of the expansion card 24 acquired through the complete simulation model 10′. FIG. 6 illustrates a graph of the relationship between the cooling flow of the expansion card 24 and the corresponding temperature of the expansion card 24 acquired through the complete simulation model 10′. The complete simulation model 10′ is simulated in the thermal simulation software, referring to parameters of all members in the host 10, a computational complexity is increased. Thus, a time of the simulation through the complete simulation model 10′ is long.

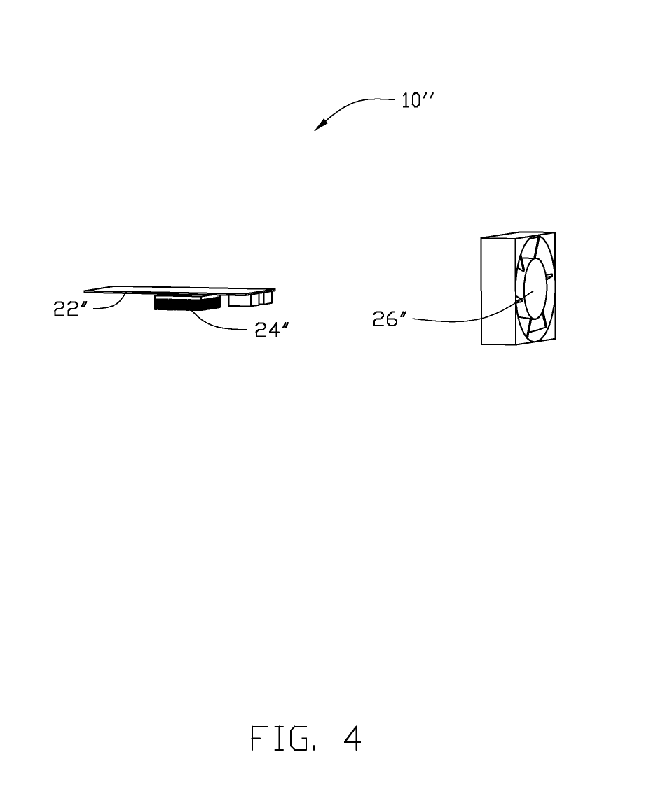

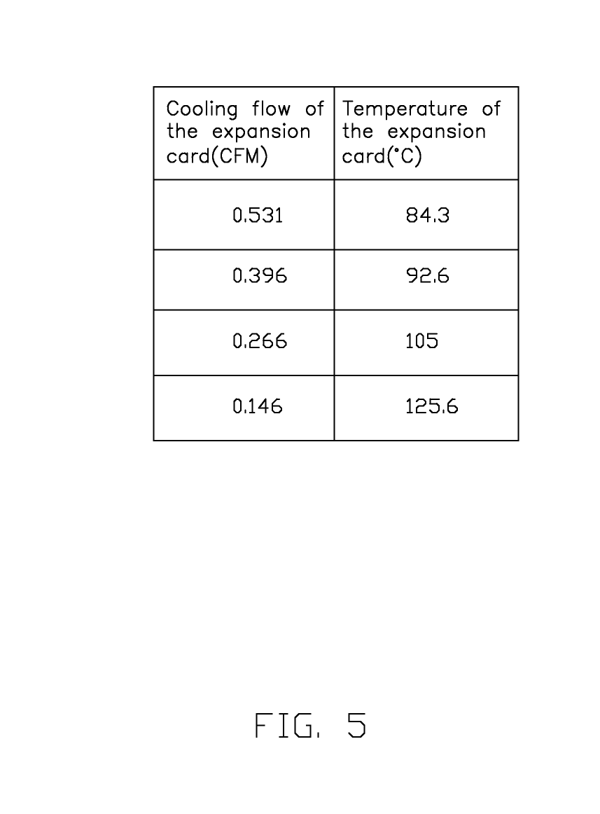

FIG. 4 illustrates a simplified simulation model 10″ including a printed circuit board 22″, an expansion card 24″ electrically connected to the printed circuit board 22″ and a fan” opposite to the printed circuit board 22″. Structures and positions of the printed circuit board 22″, the expansion card 24″ and the fan” correspond to the structures and positions of the printed circuit board 22, the expansion card 24 and the fan 26 of the host 10. When acquiring the relationship between the cooling flow of the expansion card 24 and the temperature of the expansion card 24, the expansion card 24″ is set up as an object to be simulated in the thermal simulation software. Furthermore, boundary values are set up for thermal conductivity and heat productivity of the printed circuit board 22″ and the expansion card 24″, and boundary value of a flow of the fan 26′ and an environment temperature of the host 10″. The relationship is then acquired through a simulation function of the thermal simulation software. FIG. 5 illustrates a part of date of the cooling flow of the expansion card 24 and the corresponding temperature of the expansion card 24 through the simplified simulation model 10″. FIG. 6 illustrates a graph of the relationship between the cooling flow of the expansion card 24 and the corresponding temperature of the expansion card 24 through the simplified simulation model 10″.

FIG. 6 illustrates a simulation result through the complete simulation model 10′ that is similar to a simulation result of the simplified simulation model 10″. The simplified simulation model 10″ is simulated in the thermal simulation software, referring to parameters of a part of members in the host 10, when a computational complexity is decreased. Thus, a time of the simulation through the simplified simulation model 10″ is shorter than the time of simulation through the complete simulation model 10′.

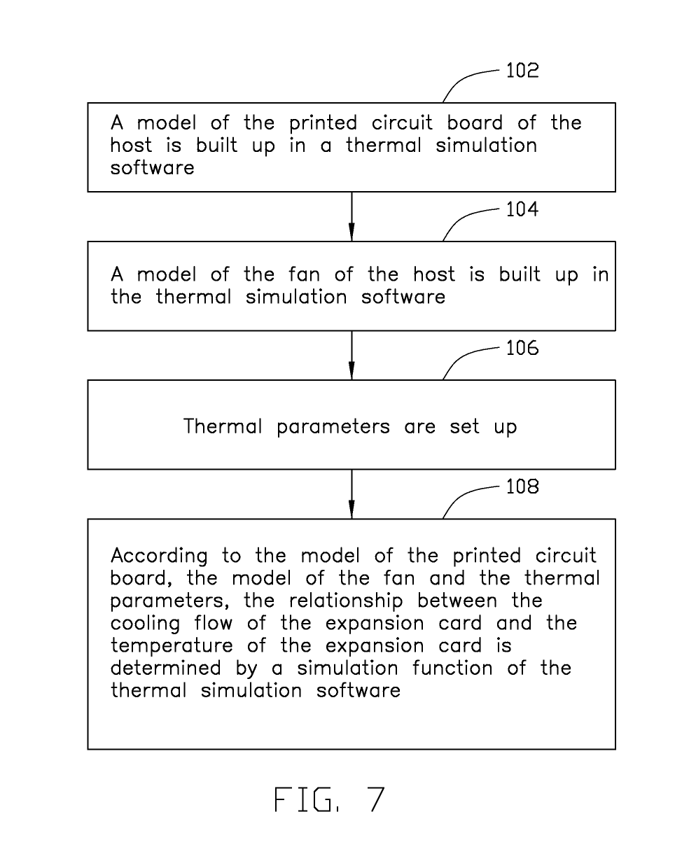

FIG. 7 illustrates a flowchart of a method of acquiring the relationship between the cooling flow of the expansion card 24 and the temperature of the expansion card 24. The illustrated order of blocks in FIG. 7 is illustrative only and the order of the blocks can change according to the present disclosure. Additional blocks can be added or fewer blocks may be utilized, without departing from this disclosure. The example method can begin at block 102.

At block 102, a model of the printed circuit board 22 of the host 10 is built in a thermal simulation software. The model of the printed circuit board 22 includes a printed circuit board 22″ and an expansion card 24″ attached to the printed circuit board 22″

At block 104, a model of the fan 26 of the host 10 is built up in the thermal simulation software. Structures and positions of the model of the printed circuit board 22 and the model of the fan 26 in the thermal simulation software are the same as structures and positions of the printed circuit board 22, the expansion card 24 and the fan 26 of the host 10.

At block 106, thermal parameters are set up. The thermal parameters include boundary values of thermal conductivity and heat productivity of the printed circuit board 22″ and the expansion card 24″, and boundary value of a flow of the model of the fan 26 and an environment temperature of the host 10.

At block 108, according to the model of the printed circuit board 22, the model of the fan 26 and the thermal parameters, the relationship between the cooling flow of the expansion card 24 and the temperature of the expansion card 24 is determined by a simulation function of the thermal simulation software.

The embodiments shown and described above are only examples. Even though numerous characteristics and advantages of the present technology have been set forth in the foregoing description, together with details of the structure and function of the present disclosure, the disclosure is illustrative only, and changes may be made in the details, including in matters of shape, size and arrangement of the parts within the principles of the present disclosure up to, and including, the full extent established by the broad general meaning of the terms used in the claims.

What is claimed is:

1. A method for acquiring a cooling flow of an expansion card electrically connected to a circuit board of a host, the host further comprising a shell, a power supply unit, a hard disk, a central processor unit, a storage unit and a fan, the method comprising:
building up a model in a thermal simulation software, the model comprising the circuit board, an expansion card and a fan, structures and positions of the circuit board, an expansion card and a fan in the model are same as the circuit board, the expansion card and the fan of the host;
setting up thermal parameters in the thermal simulation software; and
simulating a relationship between the cooling flow of the expansion card of the host and a temperature of the expansion card of the host through a simulation function of the thermal simulation software based on the model and the thermal parameters.

2. The method as claimed in claim 1, wherein the thermal simulation software is Flotherm.

3. The method as claimed in claim 1, wherein the fan in the model is opposite to the circuit board in the model.

4. The method as claimed in claim 1, wherein the expansion card of the host is a network card.

5. The method as claimed in claim 1, wherein the expansion card of the host is an adapter card.

6. The method as claimed in claim 1, wherein the thermal parameters comprise boundary values of thermal conductivity and heat productivity of the circuit board and the expansion card, and boundary value of a flow of the model of the fan.

7. The method as claimed in claim 1, wherein the thermal parameters comprise an environment temperature of the host.

8. A method for acquiring a cooling flow of an expansion card electrically connected to a circuit board of a host, the host further comprising a shell, a power supply unit, a hard disk, a central processor unit, a storage unit and a fan, the method comprising:
building up a model of a circuit board having a structure same to the circuit board of the host in a thermal simulation software;
building up a model of an expansion card having a structure and position same to expansion card of the host in the thermal simulation software;
build up a model of a fan having a structure and position same to the fan of the host in the thermal simulation software;
setting up thermal parameters thermal simulation software; and
computing the cooling flow of the expansion card of the host corresponding to a temperature of the expansion card of the host through the thermal simulation software based on the model of the circuit board, the expansion card and the fan, and the thermal parameters.

9. The method as claimed in claim 8, wherein the thermal simulation software is Flotherm.

10. The method as claimed in claim 8, wherein the fan in the model is opposite to the circuit board in the model.

11. The method as claimed in claim 8, wherein the expansion card of the host is a network card.

12. The method as claimed in claim 8, wherein the expansion card of the host is an adapter card.

13. The method as claimed in claim 8, wherein the thermal parameters comprise boundary values of thermal conductivity and heat productivity of the circuit board and the expansion card, and boundary value of a flow of the model of the fan.

14. The method as claimed in claim 8, wherein the thermal parameters comprise an environment temperature of the host.

15. A simulation model for acquiring a cooling flow of expansion card electrically connected to a circuit board of a host, the host further comprising a shell, a power supply unit, a hard disk, a central processor unit, a storage unit and a fan, the simulation model comprising:
a model of a circuit board having a structure same to the circuit board of the host;
a model of an expansion card having a structure and position same to expansion card of the host; and
a model of a fan having a structure and position same as the fan of the host, the structures and positions of the module of the circuit board, a module of the expansion card and a module of the fan are same as the circuit board, the expansion card and the fan of the host;
wherein the simulation model is built up in a thermal simulation software to acquire a relationship between a cooling flow of the expansion card of the host and a temperature of the expansion card of the host through a simulation function of the thermal simulation software based on the models and thermal parameters set up in the thermal simulation software.

16. The simulation model as claimed in claim 15, wherein the fan in the model is opposite to the circuit board in the model.

17. The simulation model as claimed in claim 15, wherein the expansion card of the host is a network card.

18. The simulation model as claimed in claim 15, wherein the expansion card of the host is a adapter card.

19. The simulation model as claimed in claim 15, wherein the thermal parameters comprise boundary values of thermal conductivity and heat productivity of the circuit board and the expansion card, and boundary value of a flow of the model of the fan.

20. The simulation model as claimed in claim 15, wherein the thermal parameters comprise an environment temperature of the host.
